(19) United States
(12) Patent Application Publication
(10) Pub. No.: US 2020/0020047 A1
(43) Pub. Date: Jan. 16, 2020

(54) PHOTOGRAPHY VENUE CONNECTION SYSTEM AND METHOD

(71) Applicants: Nicholas Ramirez, Fort Collins, CO (US); Katie Ramirez, Port Collins, CO (US)

(72) Inventors: Nicholas Ramirez, Fort Collins, CO (US); Katie Ramirez, Port Collins, CO (US)

(21) Appl. No.: 16/509,686

(22) Filed: Jul. 12, 2019

Related U.S. Application Data
(60) Provisional application No. 62/697,017, filed on Jul. 12, 2018.

(51) Int. Cl. G06Q 50/00; G06Q 10/02

(52) U.S. Cl. CPC G06Q 50/01; G06Q 10/02

(57) ABSTRACT

A method of connecting photographers, clients, and photography venues, the method includes creating a platform having a photographer portal, a client portal, and a photography venue portal; receiving data from a photography venue through the photography venue portal to create a venue profile, the data including at least a photography attraction, a price, and a schedule of availability; providing a client with a list of venue profiles matching one or more search criteria input by the client; receiving a selection of one of the venue profiles by the client; and facilitating communication between the client and a selected venue.

### BACKGROUND

### 1. Field of the Invention

The present invention relates generally to systems and methods of connecting photographers, clients, and venues, and more specifically to a system and method that allows for venues to create profiles and schedules of availability, thereby allowing for clients and photographers to have access to a plurality of unique venues within their location.

### 2. Description of Related Art

Photography connection systems are well known in the art and are effective means to hire a photographer. For example, FIG. 1 depicts a conventional photographer selection method 101 wherein a client contacts one or more photographers, and the selected photographer provides the client with available venues, such as places that the photographer has shot before, as shown with boxes 103, 105. Once a venue is selected, the photographer and client proceed with the photoshoot, as shown with boxes 107, 109.

One of the problems commonly associated with method 101 is limited venue availability. For example, the client is usually limited to either public spaces, photography studios, or their own private property. The client may however desire a shoot with either a particular item, such as an exotic car, or at a specific site, such as a football stadium. These various venues and/or attractions are not generally available to the client for use.

Accordingly, although great strides have been made in the area of photography connection systems and methods, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flowchart of a common photography connection method;

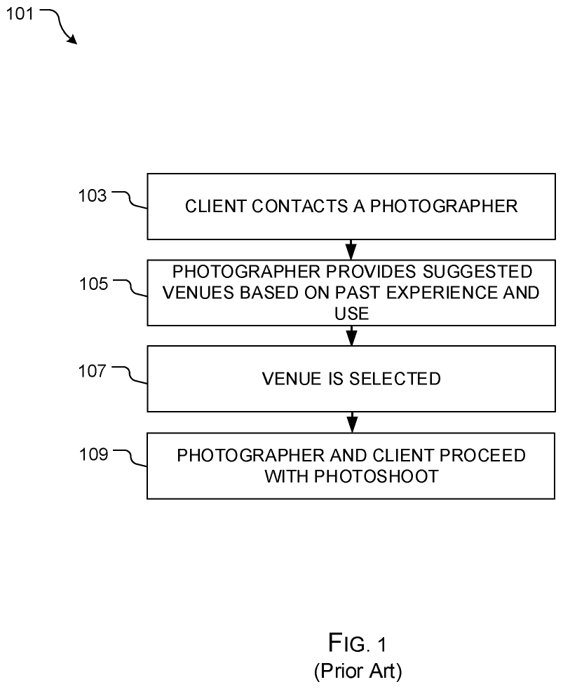

FIG. 2 is a simplified schematic of a photography connection system in accordance with a preferred embodiment of the present application;

FIG. 3 is a simplified schematic of venue portal of FIG. 2;

FIG. 4 is a simplified schematic of a client portal of FIG. 2;

FIG. 5 is a simplified schematic of a photographer portal of FIG. 2; and

FIG. 6 is a flowchart of the method of use of the system of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional photography connection systems. Specifically, the present invention provides a means to connect various photography venues with clients, thereby providing the client with an opportunity for a unique venue. In addition, the system can connect photographers, clients, and venues, making the scheduling of a photoshoot streamlined and efficient. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

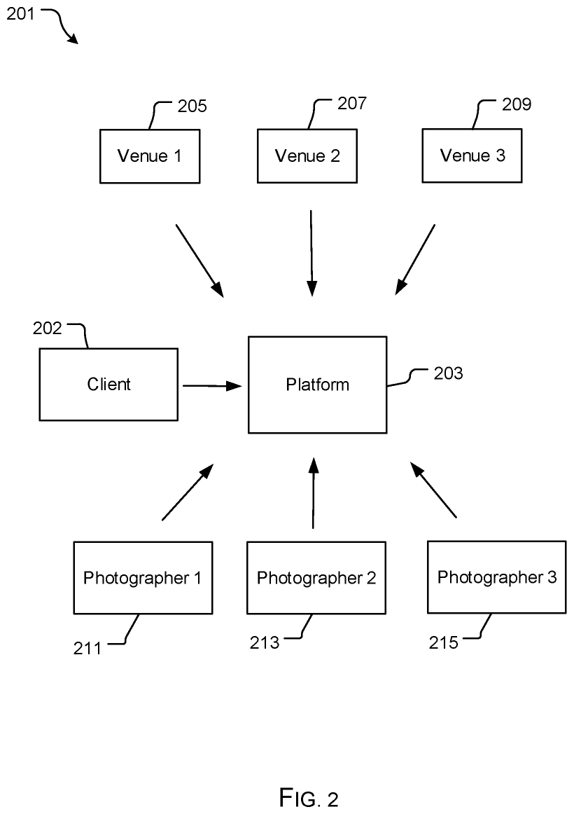

Referring now to the drawings wherein like reference characters identify corresponding or similar elements throughout the several views, FIG. 2 depicts a simplified schematic of a photography connection system 201 in accordance with a preferred embodiment of the present application. It will be appreciated that system 201 overcomes one or more of the above-listed problems commonly associated with conventional photography connection systems.

In the contemplated embodiment, system 201 includes a platform 203, which can be incorporated into a website, mobile application, or the like. Platform 203 is configured to facilitate communication and interaction between a client 202 and plurality of venues 205, 207, 209 and a plurality of photographers 211, 213, 215. Platform 203 is configured to facilitate the creation of a plurality of venue profiles, wherein the client can search for a venue based on criteria. Further, the client can search for a photographer, or alternatively, a selected photographer can search for a desired venue. It should be appreciated and understood that the plurality of photographers can be professional photographers, or can be friends/family members that are amateur photographers.

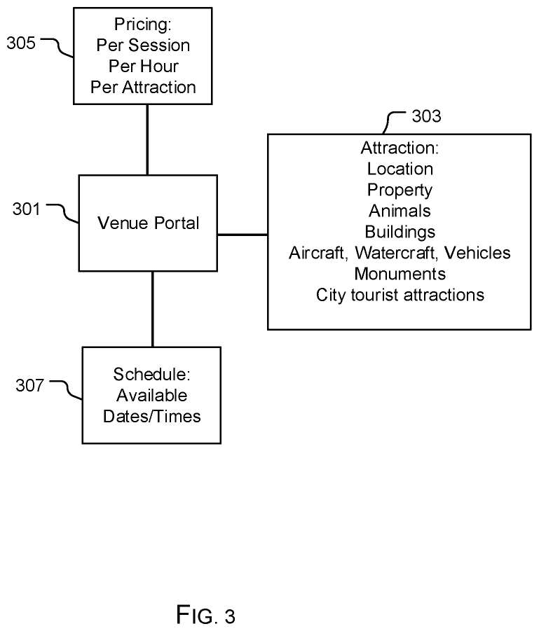

In FIG. 3, a venue profile 301 is shown, wherein each of the plurality of venues can create their profiles. The venues can input necessary data, including a photography attraction 303, pricing 305, and a schedule 307. As shown, it is contemplated that any individual or company can be a venue, and provide data as to their attraction that a client may want to use during the photoshoot

Some of the contemplated attractions 303 include: a specific location, a specific property value (fields, trees, lakes, etc.); a specific item (cars, watercrafts, aircrafts, animals, art work, sculptures, etc.); a specific attraction (local tourist attractions, monuments, sporting fields/stadiums; etc.); and even individuals, such as celebrities.

The venue can further designate their pricing 305, such as by the hour, by the attraction, by the date, by the session, etc. Thereby allowing for complete control by the venue. In some embodiments, the platform/website/mobile app developer will receive a percentage of the pricing designated by the venue.

Lastly, the venue has complete control over their schedule 307, wherein the venue can block off certain dates or times, and only allow for photoshoots at specific days/times.

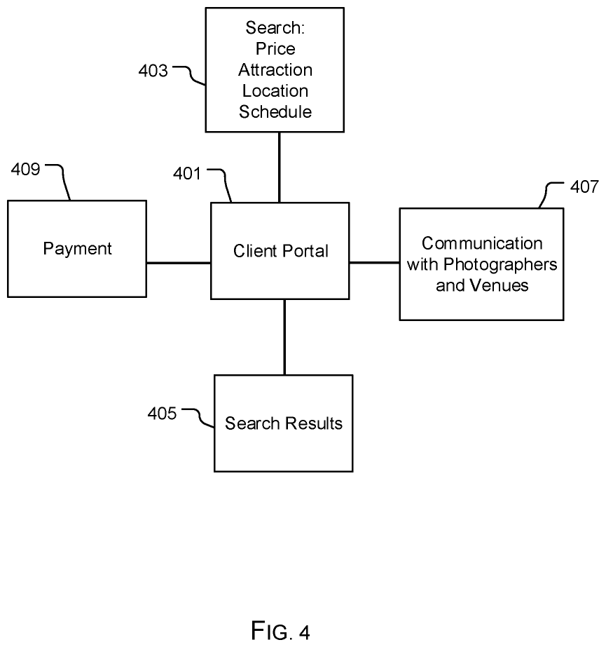

In FIG. 4, a client portal 401 is shown, wherein the client can search 403 for venues and/or photographers, based on one or more criteria, such as pricing, desired photography attraction, location, and schedule of availability. The client is then provided with search results 405, wherein the user can see availability, pricing, and attractions. Once the client selects a venue and/or photographer, the client can then directly communicate 407 with the venue/photographer for needed details.

In some embodiments, the client can pay 409 the venue and/or photographer selected directly through the platform.

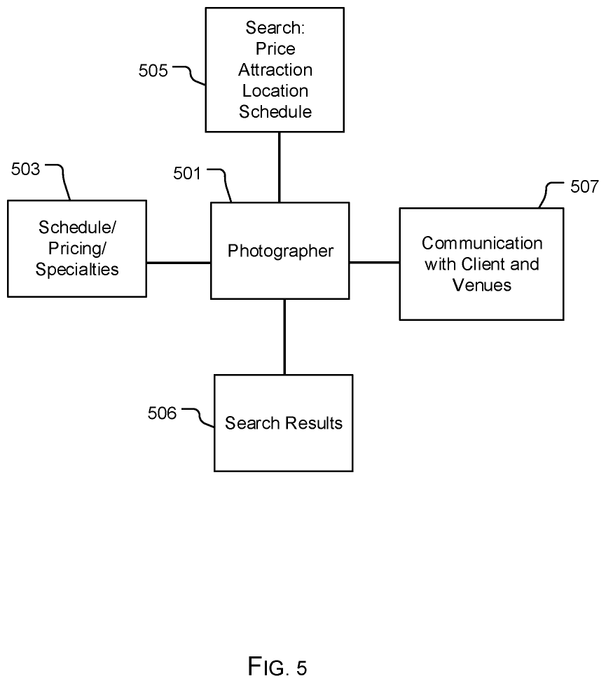

In FIG. 5, a photographer portal 501 is shown, wherein a plurality of photographers can create profiles by inputting data 503, such as price, schedules, specialties, portfolios, and the like. The photographer can also search for venues 505 based on criteria, such as price, attraction, location, and schedule. This allows for the photographer to find search results 506 for venues on behalf of a client, or for one of their clients. A communication portal 507 allows for direct communication between the photographer and a selected venue, as well as with a client.

It should be appreciated that one of the unique features believed characteristic of the present application is the creation of a database of photography venues, wherein each of the venues can set their own terms, schedule, pricing, etc. This provides clients and photographers with the opportunity for finding unique venues.

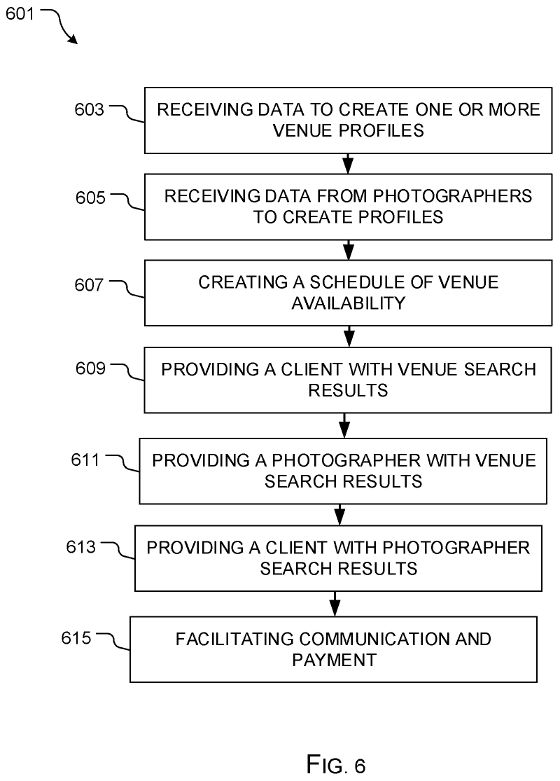

In FIG. 6, a flowchart 601 depicts the method of system 201. Venue owners input data to create profiles, thereby establishing a plurality of venue profiles, as shown with box 603. In some embodiments, photographers can also input data to create profiles, as shown with box 605. A schedule of availability is created for the plurality of venues, as shown with box 607. The client inputs criteria to receive search results, as shown with box 609. In some embodiments, the photographer can also search for venues and receive search results, as shown with box 611. The client can also search for a photographer, as shown with box 613. Once the client has selected a venue and/or photographer, a communication portal is opened between the parties, as shown with box 615.

It should be appreciated that the system and method can include various other features, including a photoshoot viewing portal, a subscription based service to allow photographers and/or venues to advertise, or any other features as are currently contemplated or will arise in the future.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A method of connecting photographers, clients, and photography venues, the method comprising:
creating a platform having a photographer portal, a client portal, and a photography venue portal;
receiving data from a photography venue through the photography venue portal to create a venue profile, the data including at least a photography attraction, a price, and a schedule of availability;
providing a client with a list of venue profiles matching one or more search criteria input by the client;
receiving a selection of one of the venue profiles by the client; and
facilitating communication between the client and a selected venue.

2. The method of claim 1, wherein the photography attraction is selected from a list of photography attractions, the list comprising:
a location;
an item, the item being one of a vehicle, an aircraft, a watercraft, and an animal;
a building; and
a tourist attraction.

3. The method of claim 1, further comprising:
receiving data from a photographer through the photographer portal to create a photographer profile;
providing the client with a list of photographer profiles; and
providing the photographer with the list of venue profiles.

4. The method of claim 3, further comprising:
facilitating payment between the client and a selected photographer.

5. The method of claim 1, further comprising:
facilitating payment between the client and the selected venue.

6. The method of claim 1, further comprising:
creating a schedule to reflect availability of a plurality of venues, wherein the schedule shows availability and unavailability based on input from each of the plurality of venues.
